(19) United States
(12) Patent Application Publication
(10) Pub. No.: US 2015/0260497 A1
(43) Pub. Date: Sep. 17, 2015

(54) INSERTION DEPTH MARKING DEVICE AND METHOD

(71) Applicant: Anderson Copper and Brass Company LLC, Oak Forest, IL (US)

(72) Inventor: Christopher Roger Haczynski, Crown Point, IN (US)

(21) Appl. No.: 14/640,650

(22) Filed: Mar. 6, 2015

Related U.S. Application Data
(60) Provisional application No. 61/954,215, filed on Mar. 17, 2014.

(51) Int. Cl. G01B 3/28

(52) U.S. Cl. CPC G01B 3/28

(57) ABSTRACT

A device for marking a generally cylindrical member includes a pair of markers positioned within a housing. The generally cylindrical member is inserted into the housing and positioned adjacent to the pair of markers. As a result, the generally cylindrical member is marked with a pair of indicators by the pair of markers when the generally cylindrical member is rotated with respect to the pair of markers. The pair of indicators enables the generally cylindrical member to be positioned at a proper depth of insertion within a fitting after the marked generally cylindrical member is removed from the marking device.

### CLAIM OF PRIORITY

This application claims priority to U.S. Provisional Application No. 61/954,215, filed on Mar. 17, 2014, the contents of which are hereby incorporated herein by reference.

### FIELD OF THE INVENTION

The present invention relates generally to pipes, tubing, conduits, rods and other generally cylindrical members used in industrial and residential applications and, in particular, to an insertion depth marking device and method for use when inserting generally cylindrical members into fittings.

### BACKGROUND

Pipes, tubing, conduits, rods and other generally cylindrical members are used in several industries and applications. For example, such components may be used for transmitting fluids. Fittings are often used to attach the component to one or more other components, which may be of the same type or a different type.

Press and/or push-to-connect type fittings, an example of which is illustrated in FIG. 1, require insertion of a tube 10 or other cylindrical member or component into a fitting 12 having a blind female hole with an annular seal 14. As a result, the end portion of the tube must be inserted into the female fitting hole to a specific depth in order for the annular seal 14 to properly seal the fluids flowing thru the tube and fitting.

In practice, after the tubing is cut to length and de-burred, installers are asked to apply a single depth mark on the tubing to be inserted before installation, and to confirm the tubing is inserted to that mark during installation. Depending upon the marking instrument (i.e. pencil, pen, marker, chalk etc.) and the lighting conditions, the line may not be visually recognizable after installation, thus not ensuring the proper depth of insertion, which can cause a failure of the joint

The prior art marking instruments have a number of additional disadvantages. For example, the marking may wear off during handling of the tube so that the single line does not provide a lasting visual verification of proper insertion that is easily recognizable. In addition, the single line does not provide an indicator that the tube has not been inserted to the proper depth. In other words, the user may believe that the marker is “close enough” to the position that indicates the proper depth of insertion. Furthermore, relying upon the installer with a tape measure and pencil to mark the correct insertion depth introduces chances for error. Inspectors of the installation are also unsure of what type of mark to look for, i.e. pencil, pen, marker or scribe line.

A need exists for a device or tool and a method for marking tubing and other generally cylindrical members for insertion into fittings that addresses at least some of the above issues.

### BRIEF DESCRIPTION OF THE DRAWINGS

FIG. 1 is a schematic view showing a tube inserted into a fitting at the correct insertion depth;

FIG. 2A is a side plan view of a tube that has been marked with an embodiment of the device of the present invention using an embodiment of the method of the present invention;

FIG. 2B is an end elevational view of the tube of FIG. 2A;

FIG. 3 is a broken away perspective view of an embodiment of the marking device of the invention;

FIG. 4 is an exploded view of the marking device of FIG. 3;

FIG. 5A is a sectional view of the marking device of FIGS. 3 and 4, with the marker cover and housing cover removed;

FIG. 5B is the marking device of FIG. 5A with a tube partially inserted;

FIG. 5C is the marking device of FIGS. 5A and 5B with the tube fully inserted;

FIG. 6A is a perspective view of the tube of FIG. 2 prior to insertion into a fitting;

FIG. 6B is a perspective view of the tube of FIG. 6A after insertion into the fitting, but at an incorrect depth;

FIG. 6C is a perspective view of the tube of FIGS. 6A and 6B after insertion into the fitting and at the correct insertion depth;

FIG. 7A is a perspective view of the marker cover of FIG. 4 just prior to insertion into the marking device of FIG. 5A;

FIG. 7B is a perspective view of the marker cover of FIG. 7A after partial insertion into the marking device of FIG. 7A;

FIG. 7C is a perspective view of the marker cover of FIGS. 7A and 7B after full insertion into the marking device of FIGS. 7A and 7B;

FIG. 8A is a side elevational view of the marker carriages of FIG. 4 just prior to engaging one another;

FIG. 8B is a side elevational view of the marker carriages of FIG. 8A engaging one another;

FIG. 8C is a cross-sectional view of the marker carriages of FIG. 8B;

FIG. 9A is a schematic view illustrating a second embodiment of the marking device of the present invention prior to insertion of a tube;

FIG. 9B is a schematic view illustrating the tube of FIG. 9A after being fully inserted into the marking device of FIG. 9A;

FIG. 10A is a schematic view illustrating a third embodiment of the marking device of the present invention prior to insertion of a tube;

FIG. 10B is a schematic view illustrating the tube of FIG. 10A after being fully inserted into the marking device of FIG. 10A;

FIG. 11A is a schematic view illustrating a fourth embodiment of the marking device of the present invention prior to insertion of a tube;

FIG. 11B is a schematic view illustrating the tube of FIG. 11A after being fully inserted into the marking device of FIG. 11A.

### DETAILED DESCRIPTION OF EMBODIMENTS

Embodiments of the present invention provide a visually verifiable insertion depth indicator for installations where a male component is inserted into a blind hole female component, and where correct insertion depth is critical for performance. The indicator provides unmistakable visual verification of proper insertion depth which aids the installer and inspector in obtaining and verifying a proper connection and preventing fitting joint failures.

While embodiments of the invention are described below in terms of tubing and plumbing and HVAC fittings, the invention has wide application and may be used with virtually any type of tubing, piping, conduits, rods or other generally cylindrical members or components and fittings.

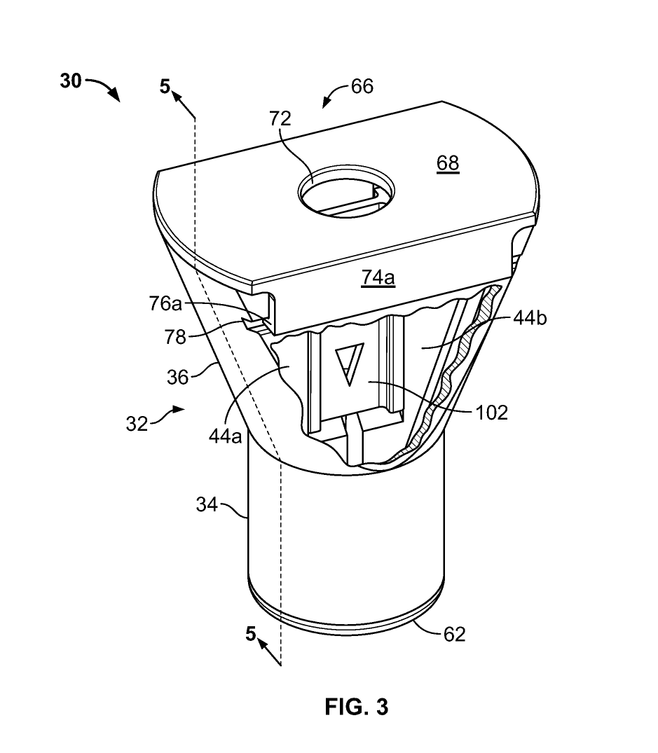

In accordance with an embodiment of the present invention, prior to insertion into a fitting, and with reference to FIGS. 2A and 2B, tubing 20 is provided with a first marked indicator, in the form of band region 22 having a width B, and a second marked indicator, in the form of band region 24 having a width D. The two band regions are separated by an annular unmarked portion of tubing 26 having a width C. In an alternative embodiment, the unmarked portion 26 may be omitted so that the two band regions abut one another. The two band regions 22 and 24 differ from the remaining surface of the tubing, and from one another, in terms of appearance. For example band region 22 may be a first color and band region 24 may be a second color, both of which differ from the color of the remaining tube surface.

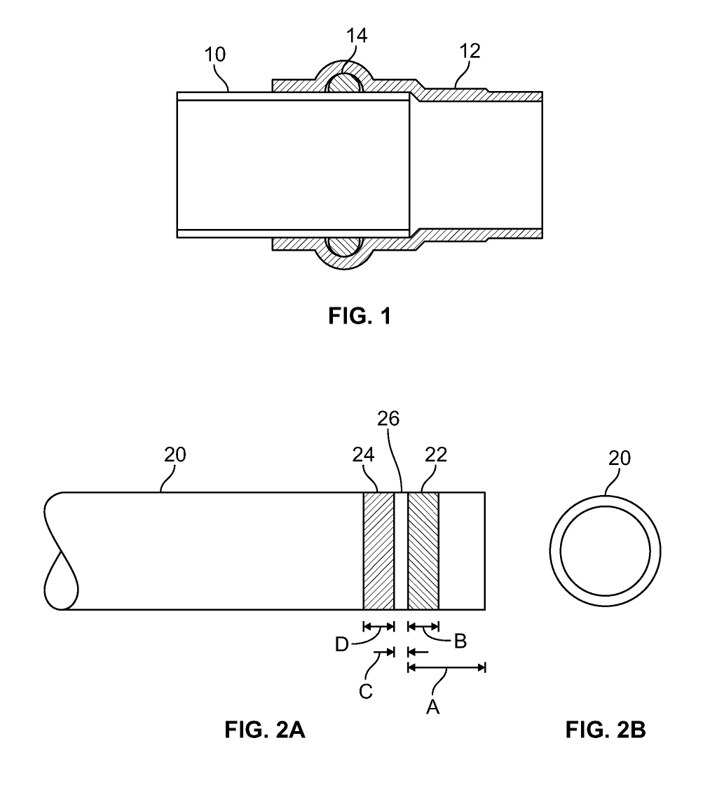

The distance indicated as A in FIG. 2A represents the minimum insertion distance to make a proper seal. The band region 22, having width B, indicates improper installation of the tubing 20 within a fitting when visible. The distance A+C in FIG. 2A is the proper full insertion distance of the tubing into the fitting (which corresponds to the condition illustrated in FIG. 1). The band region 24, having a width D, indicates proper installation of the tubing 20 within a fitting when visible.

As an example, the first band region 22 may be red in color. When the tubing is inserted into a fitting, and the first band region 22 is visible, this indicates that the appropriate installation depth has not been reached. This region 22 is determined by the tolerance range of the fitting. The indicator region 22 is preferably red and configured as a band or ring, but it could be any color and be in any format from a word or letters, shapes or dashes.

The second band region 24 may be green in color and, when solely visible after the tubing 20 is inserted into a fitting, it confirms that the tubing has been inserted into the proper depth within the fitting. The indicator region 24 is preferably green and configured as a band or ring, but it could be any color and be in any format from a word or letters, shapes or dashes.

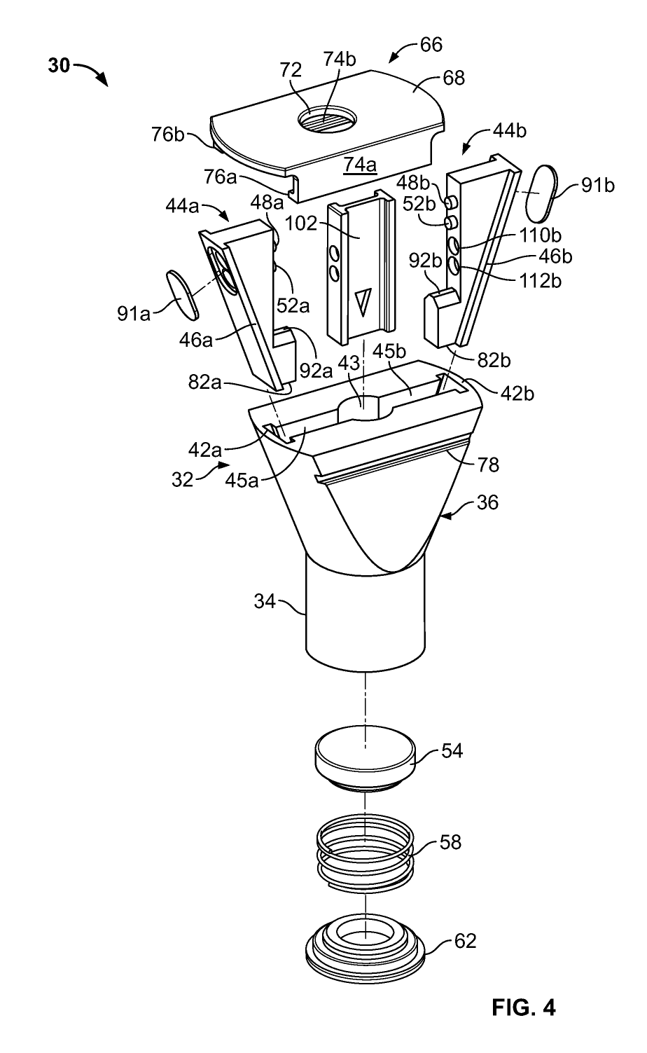

A marking device that may be used to provide the markings of FIG. 2A is indicated in general at 30 in FIGS. 3, 4 and 5A. The device includes a housing, indicated in general at 32, that includes a cylindrical piston housing portion 34 and a tapered marker carriage housing portion 36. The housing is preferably constructed from molded plastic, but other materials could be used.

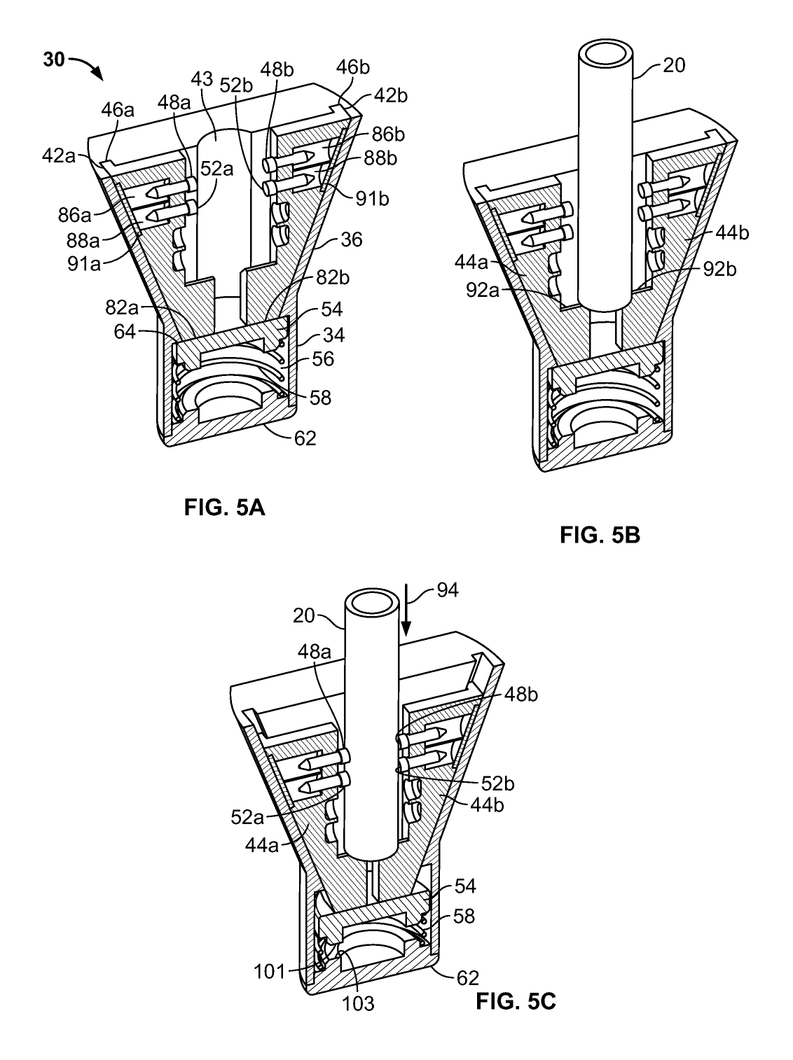

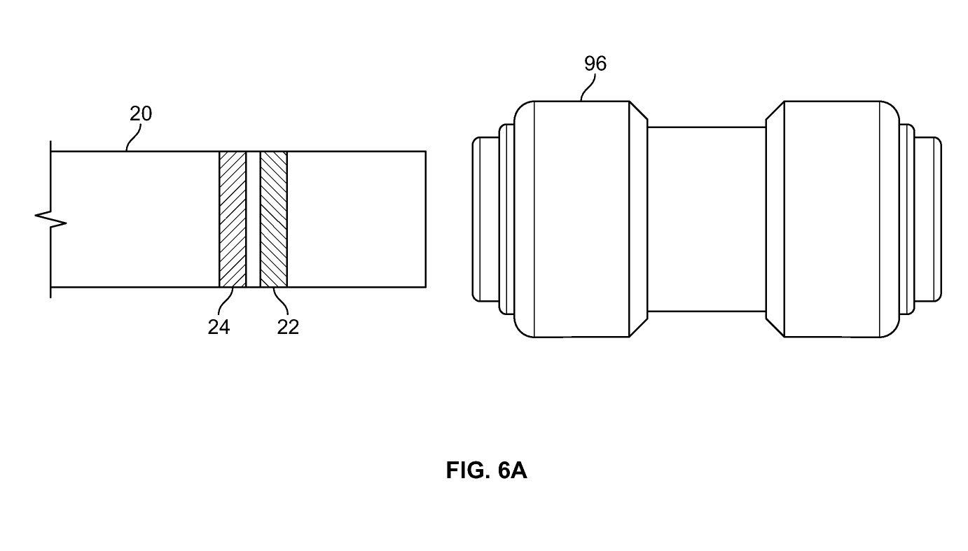

As best shown in FIGS. 4 and 5A, the marker carriage housing portion includes a pair of opposing carriage channels or tracks 42a and 42b that are angled inward in a direction towards the bottom of the marker carriage housing portion (i.e. in the direction of insertion into the device or housing 32). A bore 43 is formed in the center of the marker carriage housing portion and is flanked by a pair of marker carriage guide slots 45a and 45b. A pair of marker carriages, indicated in general in FIGS. 4 at 44a and 44b, feature flanges 46a and 46b that are sized to engage and slide within tracks 42a and 42b, while the remaining portions of the marker carriages travel within slots 45a and 45b. The marker carriages are also provided with a first pair of ink pad markers 48a and 52a and a second pair of ink pad markers 48b and 52b.

In the embodiment of FIGS. 3-8C, and all further embodiments, the markers alternatively may make take the form of a marking tool other than ink pads or pens, including, but not limited to, an indentation or cutting tip or blade.

In addition, while each of the illustrated embodiments includes a first and second pair of markers, a single pair of markers may alternatively be used as the sole marking arrangement.

With reference to FIGS. 4 and 5A, a piston 54 is positioned within a cylindrical cavity 56 defined by the piston housing portion 34. The piston is sized so that it is free to move up and down within the cavity 56. A compression coil spring 58 is also positioned within the cavity of the piston housing portion 34 and has a top end that engages the underside of the piston 54. A piston housing cap 62 closes the otherwise open bottom end of the cavity 56 and engages the bottom end of the spring so as to urge the piston upward into the position illustrated in FIG. 5A, where it engages an annular shoulder 64 defined between the cavity 56 and the bottom ends of carriage tracks 46a and 46b interior of the marker carriage housing 36. The bottom cap may be secured to the piston housing portion by adhesive or any other fastening arrangement known in the art.

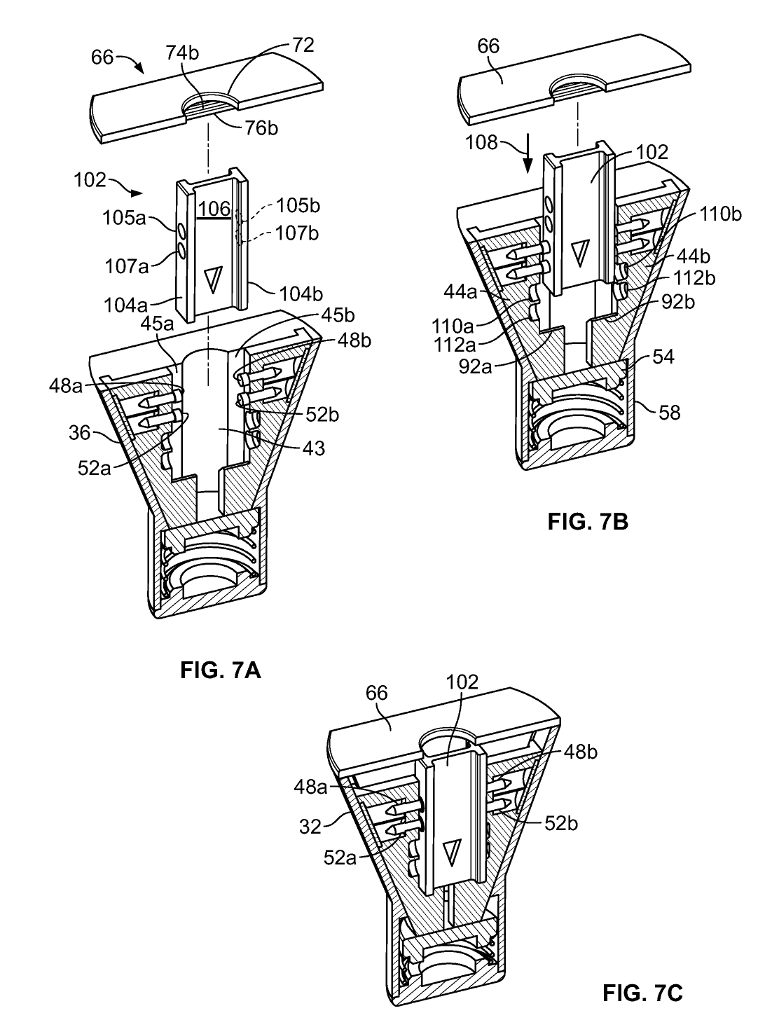

As illustrated in FIGS. 3 and 4, a housing cover, indicated in general at 66, features a central plate portion 68 having an opening 72. The central plate portion has a pair of downward extending skirt portions 74a and 74b formed on opposite side edges that feature inward extending slider tabs 76a and 76b (also shown in FIG. 7A). As illustrated in FIG. 3, skirt portions 74a and 74b and slider tabs 76a and 76b are sized and positioned so that slider tab 76a engages a groove 78 formed on the carriage housing portion 34 and slider tab 76b engages a similar groove formed on the side of the marker carriage housing portion not visible in FIG. 3. As a result, the housing cover is secured to the top end of the marker carriage housing portion in a sliding fashion and may be removed to permit the marker carriages 44a and 44b to be slid out of the marker carriages tracks, and thus out of the housing, for refilling or replacement.

As illustrated in FIGS. 4 and 5A, the bottom ends of the marker carriages 44a and 44b are provided with piston abutment surfaces 82a and 82b that are engaged by the top surface of piston 54. As a result, when the cover 66 is in place upon the top of the marker carriage housing portion (as illustrated in FIG. 3), the marker carriages 44a and 44b are urged into the position illustrated in FIG. 5A (where the cover 66 has been omitted for clarity).

As shown in FIG. 5A, the markers 48a, 48b, 52a and 52b are secured in place by sockets that communicate with ink chambers 86a, 86b, 88a and 88b which contain and supply ink to the ink pad markers. Outer covers 91a and 91b (FIGS. 4 and 5A) cover the ink chambers and may optionally be removable to permit re-filling of the ink chambers. Alternatively, the covers 91a and 92b may be permanently secured in place, such as by adhesive, for embodiments where the marker carriages are disposable.

Use of the marking device 30 in providing markings such as those illustrated at 22 and 24 in FIG. 2A will now be explained with reference to FIGS. 5A-5C. It is to be understood that the housing cover 66 is in the position illustrated in FIG. 3 during use of the device for marking, but it that it has been omitted from FIGS. 5A-5C for ease of viewing.

As illustrated in FIG. 5B, the tube 20, prior to being marked in the manner illustrated in FIG. 2, is inserted into the bore 43 (FIG. 5A) of the device, after passing through the opening 72 (FIGS. 3 and 4) of the cover 66 until the distal end of the tube engages the tube abutment surfaces 92a and 92b of the marker carriages 44a and 44b.

With reference to FIG. 5C, the user continues to push the tube 20 into the bore of the device (i.e. in the direction of insertion into the housing, indicated by arrow 94) which causes the marker carriages 44a and 44b to travel downward against the urging of piston 54 and compression coil spring 58. Due to the inwardly angled configuration of the carriage tracks 42a and 42b, the markers 48a, 48b, 52a and 52b move inwards, towards the tube until they contact the tube surface, as illustrated. The tube 20 is then rotated so that the markers form the band regions 22 and 24 of FIG. 2A.

Insertion of the tube 20 into the device may be limited by the inward travel of the marker carriages, and the resulting engagement of the tube with markers 48a, 48b, 52a and 52b, as illustrated in FIG. 5C, or, alternatively, by the abutment of annular piston stop 101 (FIG. 5C) with the corresponding annular stop 103 of the piston housing cap 62, or a combination of the two.

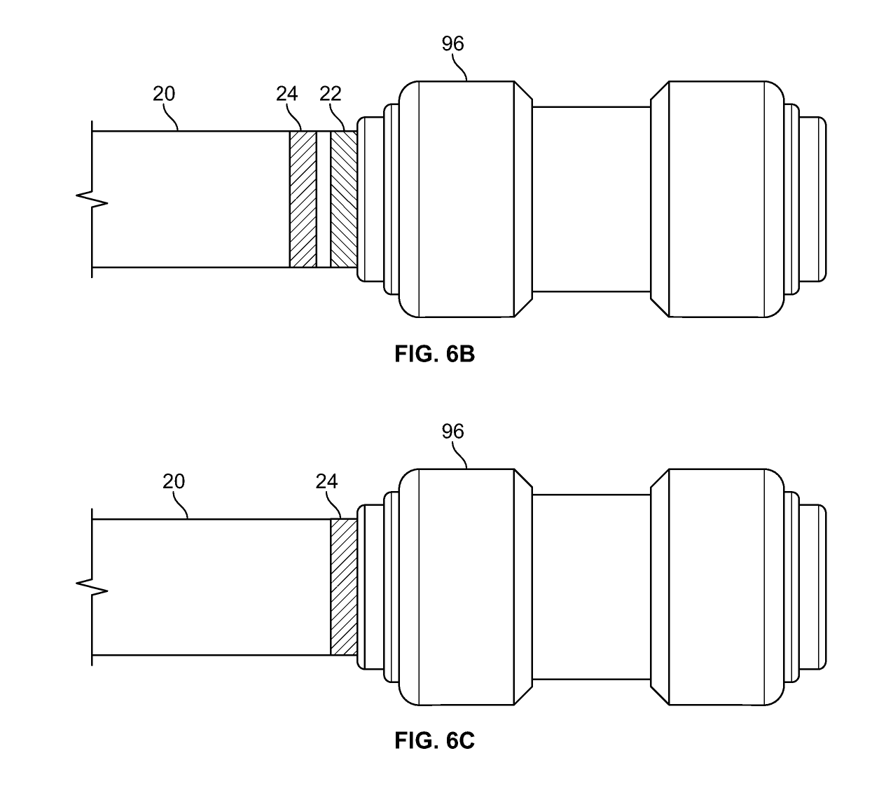

Once the tube 20 is marked as described above, it is ready to be inserted into the selected fitting, such as the fitting 96 of FIGS. 6A-6C. FIG. 6A shows the tube prior to insertion into the fitting. In FIG. 6B, the tube is shown inserted into the fitting, but the tube has not been fully or correctly inserted. This is indicated by the band region 22 (red) still being visible. In FIG. 6C, however, the tube has been fully and properly/correctly inserted into the fitting. This condition is indicated by band region 24 (green) being the only visible region (i.e. band region 22 is hidden from view by the fitting 96). It should be noted that if the tube 20 is inserted too far into the fitting, no band region will be visible, which also indicates an improper/incorrect insertion depth.

While two bands have been selected for the illustration, but more bands, rings or markings could be added to indicate branding, to indicate that the appropriate fittings are used or to indicate different types of fluid flowing thru the fitting. In addition, as noted previously, spacing between the bands may be omitted.

A marker cover, indicated at 102 in FIGS. 3 and 4, and in general at 102 in FIG. 7A, is provided. The marker cover features an I-beam shape with end flanges 104a and 104b sized to engage and slide within the marker carriage guide slots 45a and 45b. The end flanges 104a and 104b are joined by a central web portion 106 and feature marker cover indentations 105a and 107a and, as illustrated in phantom in FIG. 7A, marker cover indentations 105b and 107b. Of course the marker cover may feature other shapes in terms of cross section or overall.

In order to insert the marker cover 102 into the device, the housing cover 66 is slid off of the housing. The marker cover may then be slid into the device (being too large to fit through the opening 72 of the cover 66) until the bottom end of the beam 102 contacts the tube abutment surfaces 92a and 92b of the marker carriages. The marker cover is then pushed further into the device, in the direction of arrow 108 in FIG. 7B. As a result, the marker carriages 44a and 44b are pushed downward, thus forcing piston 54 downward against the urging of spring 58.

As the marker carriages 44a and 44b move downwards, the markers 48a and 48b move towards one another, as do markers 52a and 52b. When the beam 102 is fully inserted into the device, as illustrated in FIG. 7C, the markers 48a, 48b, 52a and 52b are positioned within the corresponding marker cover indentations 105a, 105b, 107a and 107b of the beam 102. As a result, the markers are covered or capped to prevent their ink from drying out during storage and non-use of the device. As illustrated in FIGS. 3 and 7C, the housing cover 66 is replaced upon the housing 32 to hold the beam 102 in the position whereby the markers are covered.

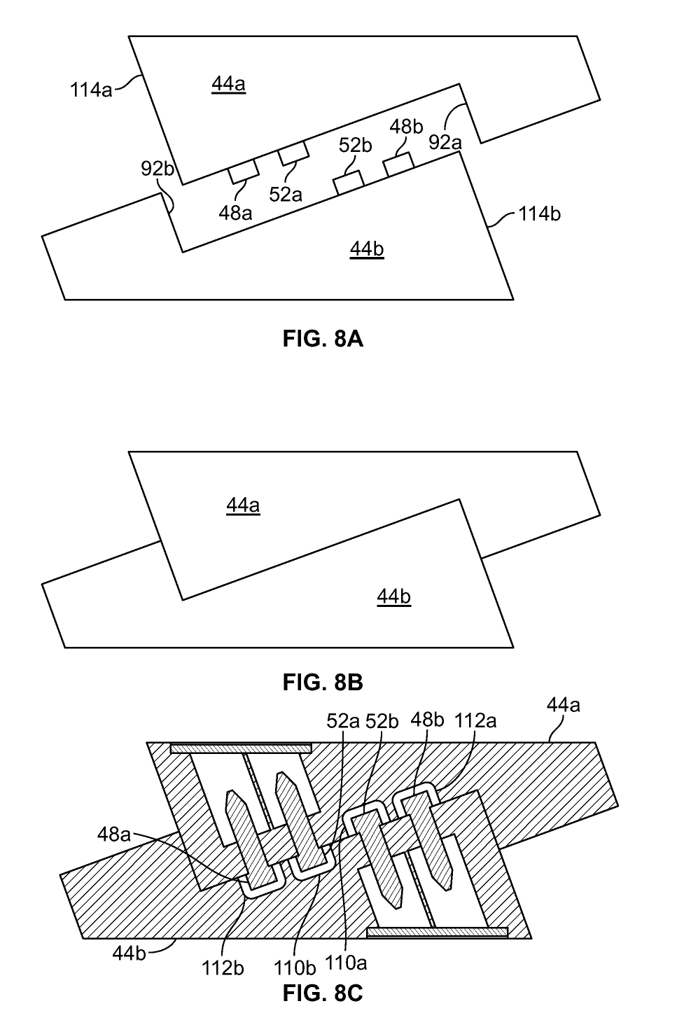

Shipping marker indentations, indicated at 110a, 110b, 112a and 112b in FIG. 7B (and FIG. 4), are also optionally provided on the marker carriages 44a and 44b. As illustrated in FIGS. 8A and 8B, the marker carriages may be removed from the housing of the device, one of the carriages inverted with respect to the other and then joined together. In such a configuration, the tube abutment surface 92a of marker carriage 44a abuts the surface 114b of marker carriage 44b. The tube abutment surface 92b of the marker carriage 44b similarly abuts the surface 114a of marker carriage 44a. When in this position, as illustrated in FIG. 8C, the markers 48a and 48b are positioned within the shipping marker indentations 110a and 110b, respectively. Furthermore, markers 52a and 52b are positioned within marker indentations 112a and 112b, respectively. This provides the marker carriages 44a and 44b with a compact configuration during shipment (thus providing compact packaging for replacement marker carriages) or storage and also protects the markers and prevents them from drying out during such events.

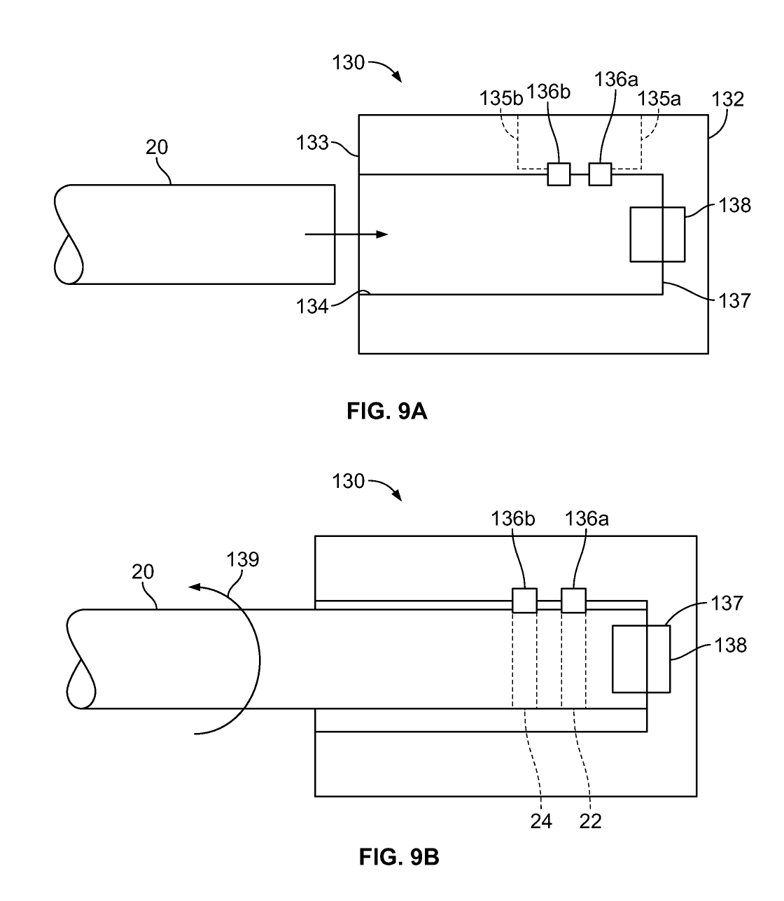

A second embodiment of a marking device or tool for providing the markings of FIG. 2. is indicated in general at 130 in FIGS. 9A and 9B. The tool features a housing 132 that contains a cylindrical chamber 134 and features an opening 133 on one end. A pair of ink marking pads or pens 136a and 136b are positioned within the chamber 134 and serve as marking members. The pads or pens can be integrated or replaceable depending upon the model of tool. Alternatively, the pads or pens could be refillable from external sources of ink through passages formed in the housing 132 (indicated in phantom at 135a and 135b in FIG. 9A). Ink is a general term, but can entail any type of color fluid that can be applied to the tubing 20.

The end of the housing 132 opposite opening 133, indicated at 137, forms a stop. In addition, the housing of the tool preferably includes a window 138 that provides a view of the stop 137 and the portion of the cylindrical chamber adjacent to the stop.

Use of the device or tool 130 of FIGS. 9A and 9B will now be described. Typically, prior to insertion into a fitting, tubing is cut to length and appropriately de-burred inside and outside. Next, and in accordance with an embodiment of the present invention, the tube 20 is inserted through the opening 133 and into the chamber 134 of the tool until the end of the tube 20 abuts the stop 137, as illustrated in FIG. 9B. The window 138 provides the user with visual sight and verification that the end of the tube has contacted the stop 137.

Next, the tube 20 is rotated, as indicated by arrow 139 of FIG. 9B. The marking pads are positioned within the cylindrical chamber 134 so as to create/mark the first and second band regions on the tubes, as indicated in phantom at 22 and 24 of FIG. 9B. The tubing 20 may then be removed from the tool 130 and is ready for insertion into a fitting as described above.

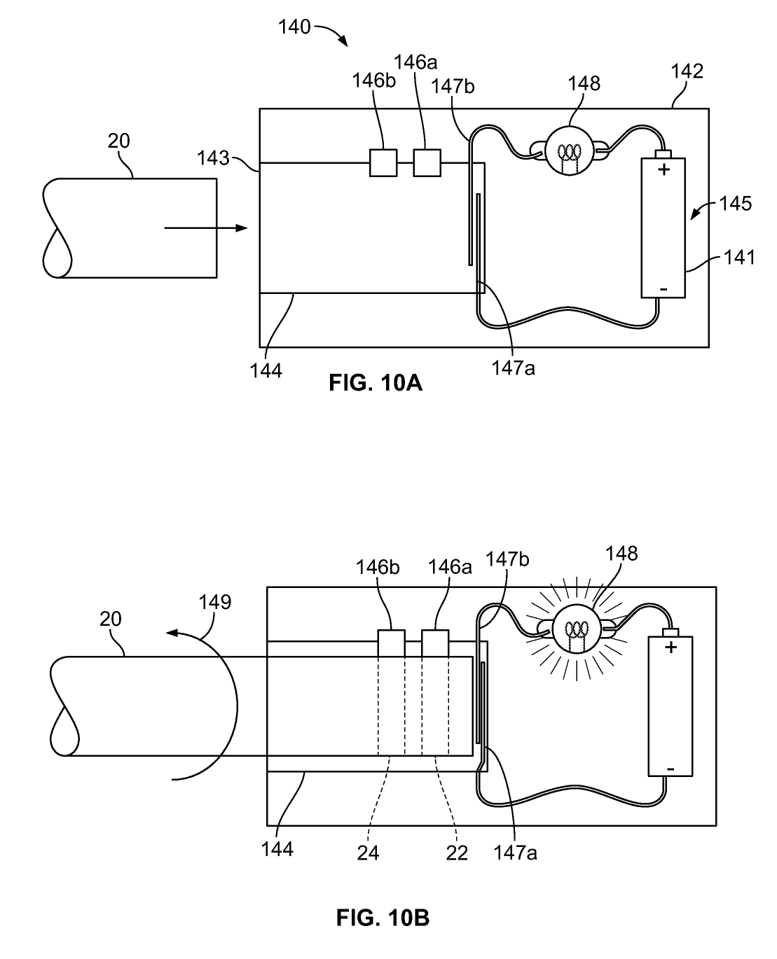

A third embodiment of a marking device or tool for providing the markings of FIG. 2. is indicated in general at 140 in FIGS. 10A and 10B. The tool features a housing 142 that contains a cylindrical chamber 144 and features an opening 143 on one end. A pair of ink marking pads or pens 146a and 146b are positioned within the chamber 144. The pads or pens can be integrated or replaceable depending upon the model of tool or may be refillable from external sources of ink through passages formed in the housing 142.

The housing 142 also encloses an electrical circuit, indicated in general at 145 in FIG. 10A, which includes a battery 141. The battery communicates electronically with a switch having contacts 147a and 147b and a light source 148, which is visible from the exterior of the tool. As will now be explained, the contacts 147a and 147b form the stop of the tool.

In operation, after the tubing 20 is cut to length and appropriately de-burred inside and outside, it is inserted through the opening 143 and into the chamber 144 of the tool until the end of the tube 20 abuts and closes the contacts 147a and 147b, as illustrated in FIG. 10B. With the contacts 147a and 147b closed, the electrical circuit 145 is closed and the battery 141 causes the light source 148 to illuminate. As a result, the illuminated light source 148 indicates that the tube 20 has been properly and fully inserted into the tool 140. A sound source may be substituted for the light source or used in addition to the light source to provide an audible indication that the tube has been properly and fully inserted into the tool 140.

Next, the tube 20 is rotated, as indicated by arrow 149 of FIG. 10B. The marking pads are positioned within the cylindrical chamber 144 so as to create/mark the first and second band regions on the tubes, as indicated in phantom at 22 and 24 of FIG. 10B. The tubing 20 may then be removed from the tool 140 and is ready for insertion into a fitting as described above.

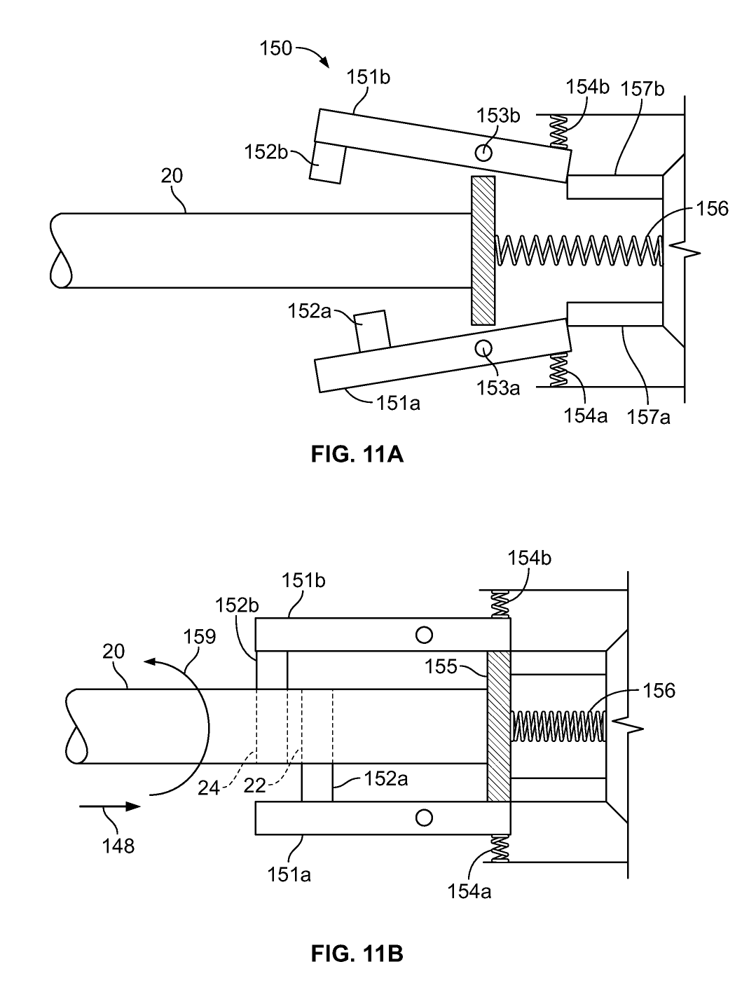

A fourth embodiment of a marking device or tool for providing the markings of FIG. 2. is indicated in general at 150 in FIGS. 11A and 11B. The tool features a housing within which is positioned (understood to include positioned on the housing as well) a pair of lever arms 151a and 151b. A pair of ink marking pads or pens 152a and 152b are mounted on the distal end portions of the lever arms. The pads or pens can be integrated or replaceable depending upon the model of tool or may be refillable from external sources of ink. The lever arms are pivotally mounted on the tool by pins 153a and 153b. The proximal ends of the lever arms are engaged by compression springs 154a and 154b, and urge the lever arms into the open position illustrated in FIG. 11A. A stop plate 155 is positioned in the tool so as to slide within the tool housing and is engaged by a compression spring 156, which urges the stop plate into the position illustrated in FIG. 11A. The tool also includes a pair of stop tabs 157a and 157b.

In operation, after the tubing 20 is cut to length and appropriately de-burred inside and outside, as illustrated in FIG. 11A, it is inserted into the tool so that the end of the tube engages the stop plate 155. With reference to FIG. 11B, the tube is then pushed into the tool, as indicated by arrow 148, until the stop plate 155 engages stop tabs 157a and 157b. As a result, the stop plate 155 engages the proximal ends of the lever arms 151a and 151b so that they pivot clockwise and counterclockwise, respectively, so that the pads or pens 152a and 152b contact the tube 20. The force applied in the direction of arrow 148 as the tube is pushed into the device has to be large enough to overcome the resisting forces of springs 154a, 154b and 156, which are compressed as the tube and stop plate 155 move into the positions illustrated in FIG. 11B.

Next, the tube 20 is rotated, as indicated by arrow 159 of FIG. 11B. The marking pads 152a and 152b create/mark the first and second band regions on the tubes, as indicated in phantom at 22 and 24 of FIG. 11B. The tubing 20 may then be removed from the tool 150 and is ready for insertion as will be described below. After the tube 20 is removed from the tool, the springs 154a, 154b and 156 cause the tool to reset into the configuration illustrated in FIG. 11A. An advantage of this embodiment of the device of the invention is that the tube is not marked until it is fully inserted into the tool 150. As a result, operator error is taken out of the marking stage of the process.

In still further alternative embodiments, the band regions or other markings on the tube or other member can be performed with a radial spinning of the ink pads or pens (understood to be the same as rotating the generally cylindrical member with respect to the markers) or the tool can be created by clam shell clamping of the pads around the tubing in a various number of segments. On a premium model of tool, the ink could be sprayed or projected upon the tubing via the markers. The tool may also have adjustable stops to accommodate different marking distances and tube diameters.

In summary, the marking tools or devices of FIGS. 3-11B each have a feature that insures that the tube or other member will be inserted fully into the tool or device prior to marking. The tool provides a mark more consistent and accurate than if marked by hand. In addition, embodiments provide a consistent, reliable and accurate process for properly inserting tubes or other members into fittings that is easy to understand and is easily recognizable at a distance.

While the preferred embodiments of the invention have been shown and described, it will be apparent to those skilled in the art that changes and modifications may be made therein without departing from the spirit of the invention, the scope of which is defined by the following claims.

What is claimed is:

1. A device for marking a generally cylindrical member for proper depth of insertion into a fitting comprising:
a. a first pair of markers;
b. a housing adapted to receive and position the generally cylindrical member adjacent to the first pair of markers so that the generally cylindrical member is marked with a pair of indicators by the first pair of markers when the generally cylindrical member is rotated with respect to the first pair of markers.

2. The device of claim 1 wherein the generally cylindrical member is a tube.

3. The device of claim 1 wherein the pair of marking members include a pair of ink pads.

4. The device of claim 1 wherein the pair of indicators are a pair of colored bands.

5. The device of claim 1 further comprising:
c. a first marker carriage holding said first pair of markers;
d. said first marker carriage positioned within the housing and movable between a first position where the first pair of markers do not contact a generally cylindrical member inserted into the housing and a second position where the first pair of markers contact a generally cylindrical member inserted into the housing.

6. The device of claim 5 wherein the housing includes a bore adapted to receive a generally cylindrical member and a first marker carriage track wherein the first marker carriage track moves the first marker carriage towards the bore and the second position in a direction of insertion into the housing.

7. The device of claim 6 further comprising a housing cover removably attached to the housing and wherein the first marker carriage may be removed from the first carriage marker track and the housing when the housing cover is removed.

8. The device of claim 7 wherein the housing cover includes an opening through which a generally cylindrical device may be inserted into the bore.

9. The device of claim 6 further comprising a marker cover having a first pair of marker cover indentations, said marker cover adapted to be removably inserted into the bore and into engagement with the first marker carriage to move the first marker carriage towards the bore and the second position where the first pair of markers are positioned within the first pair of marker cover indentations.

10. The device of claim 9 further comprising a housing cover removably attached to the housing and wherein the marker cover may be removed from the housing when the housing cover is removed.

11. The device of claim 6 further comprising a spring urging the first marker carriage in a direction opposite the direction of insertion into the housing and towards the first position.

12. The device of claim 11 wherein the first marker carriage includes a first abutment surface that is engaged by a generally cylindrical member as it is moved in the direction of insertion into the housing.

13. The device of claim 12 wherein the spring is a compression spring.

14. The device of claim 13 further comprising a piston slidably positioned in the housing and having a first surface abutting the first marker carriage and a second surface abutting the coil spring.

15. The device of claim 5 further comprising:
e. a second pair of markers;
f. a second marker carriage holding the second pair of markers;
g. said second marker carriage positioned within the housing and movable between a first position where the second pair of markers do not contact a generally cylindrical member inserted into the housing and a second position where the second pair of markers do not contact a generally cylindrical member inserted into the housing.

16. The device of claim 15 wherein the housing includes a bore adapted to receive a generally cylindrical member and a first marker carriage track wherein the first marker carriage track moves the first marker carriage towards the bore and the second position in a direction of insertion into the housing and a second marker carriage track wherein the second marker carriage track moves the second marker carriage towards the bore and the second position in a direction of insertion into the housing.

17. The device of claim 16 further comprising a housing cover removably attached to the housing and wherein the first and second marker carriages may be removed from the first and second carriage marker tracks and the housing when the housing cover is removed.

18. The device of claim 17 wherein the housing cover includes an opening through which a generally cylindrical device may be inserted into the bore.

19. The device of claim 17 wherein the first marker carriage includes a first pair of shipping marker indentations and second marker carriage include a second pair of shipping marker indentations, said first pair of shipping marker indentations adapted to receive the second pair of markers and said second pair of shipping marker indentations adapted to receive the first pair of markers after the first and second marker carriages are removed from the housing, inverted with respect to one other and then joined together.

20. The device of claim 15 further comprising a spring urging the first and second marker carriages in a direction opposite the direction of insertion into the housing and towards the first positions.

21. The device of claim 20 wherein the first marker carriage includes a first abutment surface and the second marker carriage includes a second abutment surface, said first and second abutment surfaces being engaged by a generally cylindrical member as it is moved in the direction of insertion into the housing.

22. The device of claim 21 wherein the spring is a compression spring.

23. The device of claim 22 further comprising a piston slidably positioned in the housing and having a first surface abutting the first and second marker carriages and a second surface abutting the coil spring.

24. A method for inserting a generally cylindrical member into a fitting at a proper depth of insertion comprising the steps of:
a. providing a marking device that includes a pair of markers;
b. positioning the generally cylindrical member adjacent to the pair of markers;
c. rotating the generally cylindrical member with respect to the pair of markers so that first and second indicators are marked on the generally cylindrical member;
d. inserting the generally cylindrical member into the fitting so that the first indicator on the generally cylindrical member is not visible but the second indicator on the generally cylindrical member is visible.

25. The method of claim 24 wherein the first and second indicators are colored bands differing in color.
